(19) United States
(12) Patent Application Publication
(10) Pub. No.: US 2017/0243206 A1
(43) Pub. Date: Aug. 24, 2017

(54) COMMON INTERFACE/EXPERIENCE FOR MOBILE WALLET SYSTEMS AND METHODS

(71) Applicant: Wal-Mart Stores, Inc., Bentonville, AR (US)

(72) Inventors: Bradley Joseph Kieffer, Rogers, AR (US); Eytan Daniyalzade, San Francisco, CA (US); Prasanna Rajendran, Bentonville, AR (US); Charles David Berry, Fayetteville, AR (US); David Martin Nelms, Rogers, AR (US); Daniel Eckert, Rogers, AR (US); Mark Matthews, Rogers, AR (US)

(21) Appl. No.: 15/308,482

(22) PCT Filed: Oct. 12, 2015
(86) PCT No.: PCT/US15/55140

§ 371 Date: Nov. 2, 2016

(51) Int. Cl. G06Q 20/38; G06Q 20/20; G06Q 20/32; G06Q 20/36

(52) U.S. Cl. CPC G06Q 20/38215; G06Q 20/3672; G06Q 20/202; G06Q 20/3226; G06Q 20/385; H04W 4/008

(57) ABSTRACT

Provided are common user experience for a mobile wallet system and methods. The system may include generally a mobile application operated on a mobile device, a mobile backend, a wallet broker, a point of sale (“POS”), and authorizer(s). The system allows a customer to receive encoded/encrypted data by scanning a code, or by receiving a wireless message, such as a Bluetooth low energy transmission or a near field communication, regardless of the mobile application or operating system. Mobile backend systems translate the messages so the customer does not have to do something different for different mobile applications. The system may alternatively allow a cashier to scan a participating mobile application's code such as a QR code/barcode. Mobile backend systems determine which wallet to communicate with and does so on the POS behalf. The POS is isolated from complexities of integrating with different mobile applications and corresponding backend systems.

### FIELD OF THE INVENTION

The invention relates generally to a mobile wallet, and more specifically, to systems and methods for providing a common interface and/or experience for using a mobile wallet.

### BACKGROUND

Various Mobile Applications exist in the marketplace to permit the customer to interact with a merchant's point of sale system in some manner (typically payment related). Each application has unique aspects, which can potentially create confusion and complexity for the customer and/or store associate. Similar complexity exists on the point of sale system, as it must accommodate the various idiosyncrasies of multiple mobile applications. In other words, the customer or cashier must learn something new for each mobile application, and the point of sale system must be changed each time a new mobile application is integrated.

### BRIEF SUMMARY

In one aspect, provided is a method of common user experience for executing mobile payment for a transaction at a point of sale, the method comprising: scanning a code generated at the point of sale with a mobile device operating a mobile application, wherein the code includes encoded/encrypted information that is scannable by any participating mobile application; automatically establishing a communication link between the corresponding backend system and the point of sale in response to scanning of the code by the mobile device, in order to link the backend system with the transaction; and gathering customer payment profile information for use with the transaction to effect payment.

In another aspect, provided is a method of common user experience for executing mobile payment for a transaction at a point of sale, the method comprising: emitting a wireless signal generated at the point of sale, wherein the code includes encoded/encrypted information that is detectable by any participating mobile application operating on a mobile device; automatically establishing a communication link between the corresponding backend system and the point of sale in response to scanning of the code by the mobile device, in order to link the backend system with the transaction; and gathering customer payment profile information for use with the transaction to effect payment.

In another aspect, provided is a method of common user experience for executing mobile payment for a transaction at a point of sale, the method comprising: scanning a code generated with a mobile application operating on a mobile device with a scanning device of the point of sale, wherein the code includes encoded/encrypted information; automatically establishing a communication link between a wallet broker and the point of sale in response to scanning of the code, in order to link the wallet broker with the transaction; determining at the wallet broker the mobile application used to generate the code; and gathering customer payment profile information from a corresponding backend systems, based on the mobile application used to generate the code for use with the transaction to effect payment.

In another aspect, provided is a system for providing a common experience using a mobile wallet in accordance with embodiments. The system comprises: a mobile device operating a mobile application; a mobile backend system corresponding to the mobile application; a point of sale; and a wallet broker, wherein: the wallet broker is linked to a transaction performed at the point of sale to place the wallet broker in communication with the mobile application, mobile backend system and the point of sale; the wallet broker accesses the mobile backend system to obtain a customer payment profile; the wallet broker sends an authorization message to the corresponding backend system for authorization in response to receiving a request for payment authorization from the point of sale; and the wallet broker sends a standard message to the point of sale reporting the state of the authorization request.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a block diagram of a system for a common user experience for a mobile wallet, in accordance with some embodiments.

FIG. 2 is a block diagram of one portion of a system for a common user experience for a mobile wallet, in accordance with some embodiments.

FIG. 3 is a block diagram of a second portion of a system for a common user experience for a mobile wallet, in accordance with some embodiments.

FIG. 4 is a block diagram of a third portion of a system for a common user experience for a mobile wallet, in accordance with some embodiments.

FIG. 5 is a flow diagram illustrating a method of common user experience for executing mobile payment for a transaction at a point of sale, in accordance with some embodiments.

FIG. 6 is a flow diagram illustrating another method of common user experience for executing mobile payment for a transaction at a point of sale, in accordance with some embodiments.

FIG. 7 is a flow diagram illustrating yet another method of common user experience for executing mobile payment for a transaction at a point of sale, in accordance with some embodiments.

### DETAILED DESCRIPTION

Many customers are using mobile payment offerings for payment in various stores. There are many mobile payment offerings in the market place, and new mobile payment offerings are being developed and used all of the time. These multiple and new offerings often become confusing for customers. They also become complex for point of sale system developers to frequently learn a new way to pay and change the point of sale to support the next new mobile payment solution.

The present inventive concepts provide the benefit of enabling multiple mobile applications and corresponding backend systems to be used in a “common” way.

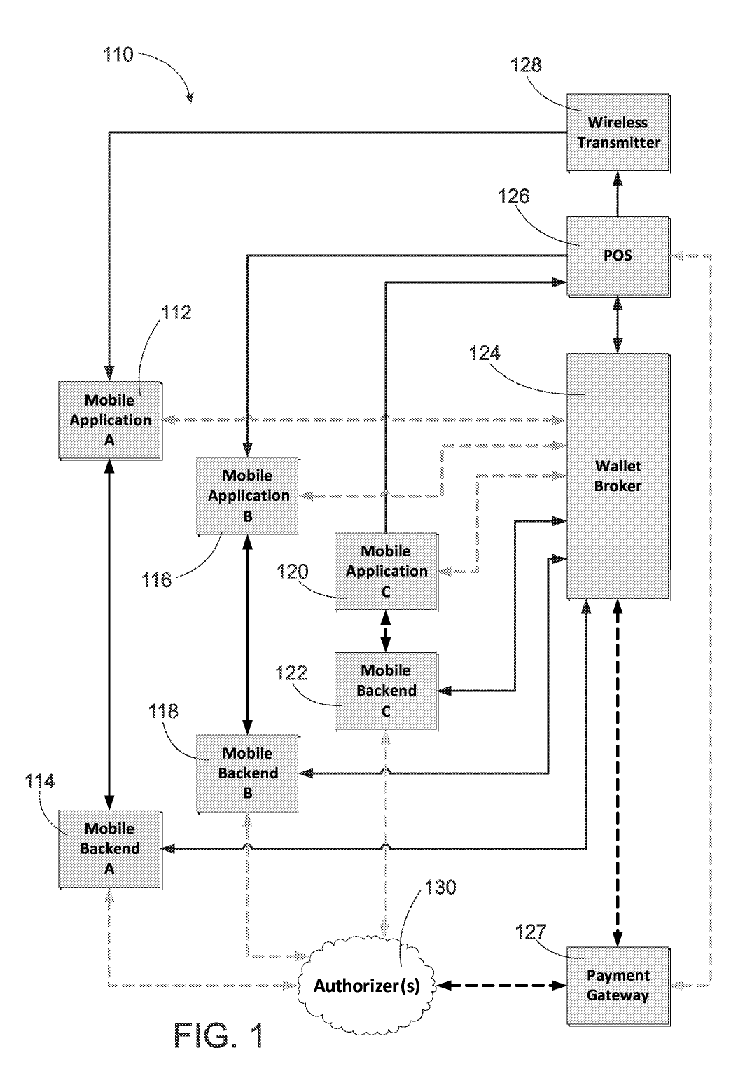

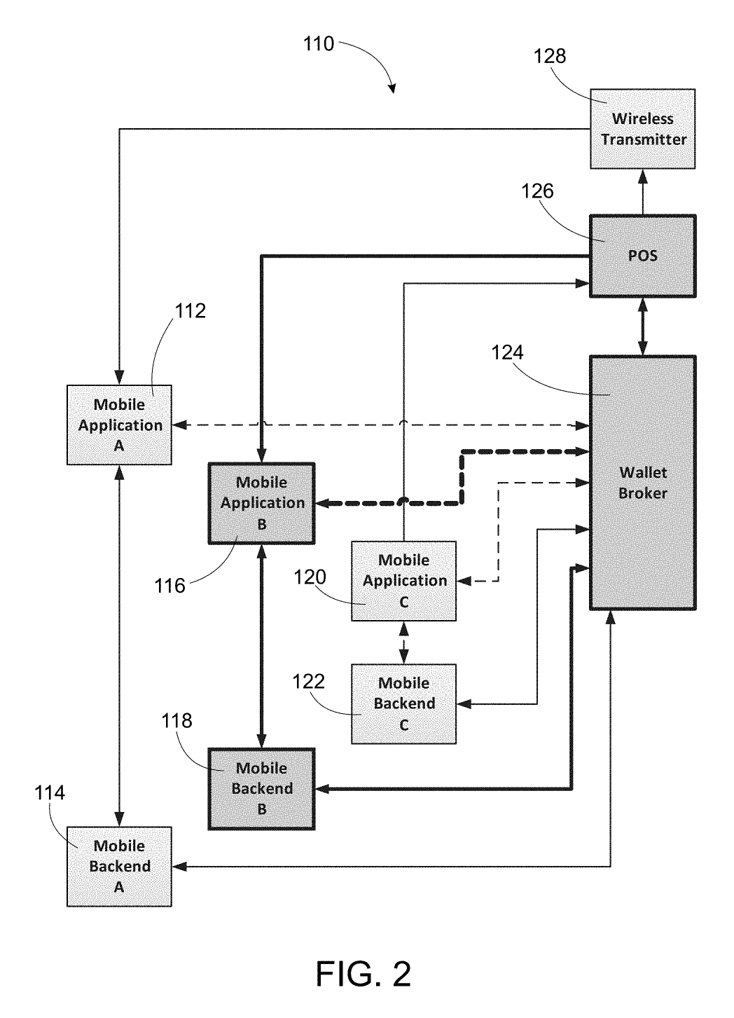

Referring to FIG. 1, a system 110 for a common user experience for a mobile wallet is depicted in accordance with embodiments. The system 110 may include generally a mobile application 112, 116, 120 operated on a mobile device, a mobile backend 114, 118, 122, a wallet broker 124, a point of sale (“POS”) 126, and authorizer(s) 130. In some embodiments, the system 110 may include a payment gateway 127. The payment gateway 127 may operate to send messages routed to the authorizers 28. FIG. 1 depicts three separate portions that are specified more clearly in FIGS. 2-4.

The mobile applications 112, 116, 120 may be an application that runs on a customer's mobile device (e.g. phone, tablet) that is the customer's primary interaction point for a transaction. Different mobile applications are published by various 3rd parties for the customer to use or internally by a particular business. The mobile applications communicate to the Mobile Backend.

The mobile backend 114, 118, 122 may expose services/API to the mobile application to provide ability to store/access data and execute business functionality. Each 3rd party application has a different ‘backend’ to support it.

The wallet broker 124 separates the PUS 126 from the differences encountered by variations in mobile applications 112, 116, 118 and mobile backend 114, 118, 122 implementations. The POS 126 interacts with wallet broker 124, which interacts with mobile applications 112, 116, 118 and mobile backend 114, 118, 122 on behalf of the POS 126.

In general, the system 110 allows a customer to scan the same code, such as a QR code/barcode, or receives the same wireless message, such as a Bluetooth low energy transmission or a near field communication, regardless of the mobile application or operating system. Mobile backend systems translate the messages so customer does not have to do something different for different mobile applications, such as, but not limited no need to push a button to make a specific barcode appear.

Also, the system 110 generally allows a cashier to scan a participating mobile application's code such as a QR code/barcode. Mobile applications and/or mobile backend systems determines to communicate with the wallet broker, which will facilitate communications with the POS 126. There is no need to go into a different mode, or specify which mobile application prior to scanning.

In system 110, the POS 126 is isolated from complexities of integrating with different mobile applications and corresponding backend systems.

Referring to FIG. 2, the system 110 includes a first portion that comprises a mobile application 116 operating on a mobile device, a mobile backend 118, a wallet broker 124 and a POS 126. The POS 126 generates and displays a code, such as, but not limited to a QR code or one-dimensional barcode, that contains encoded/encrypted information that any participating mobile application 116 can scan using the mobile device on which the mobile application 116 is operating.

When the mobile application 116 receives the code and encoded/encrypted information, the mobile application 116 may perform one of two operations. In the first operation, the mobile application 11.6 may directly communicate with the wallet broker 124 to link to the wallet broker 124 with transaction allowing communication with the mobile backend 118 and the POS 126. The wallet broker 124 may then communicate with the mobile backend system 116 to gather additional/required information, such as, but not limited to a customer payment profile.

In the second operation, the mobile application 116 may directly communication with the mobile backend system 118. By communicating directly with the mobile backend system 118, the mobile application 116 may gather additional/required information, such as, but not limited to a customer payment profile and send the information to the wallet broker 124 as part of linking the wallet broker 124 to the transaction. Alternatively, the mobile application 116 may communicate with the mobile backend 118, which may gather information to send to the wallet broker 124, which will fink the wallet broker 124 to the backend 118 and POS 126 for further information exchange, such as, but not limited to a customer payment profile.

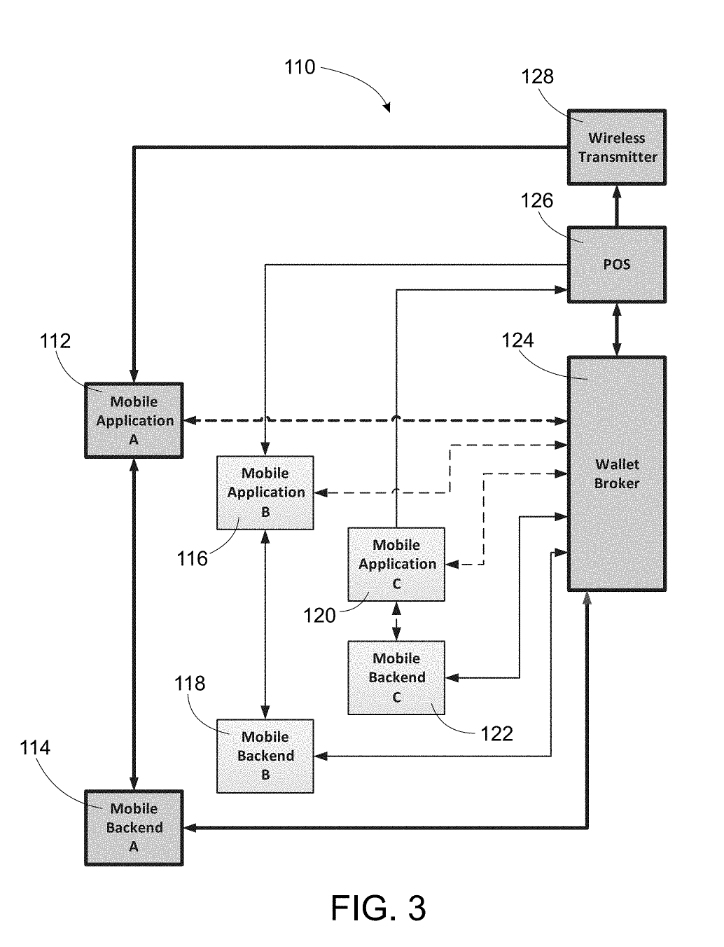

Referring to FIG. 3, the system 110 includes a second portion that comprises a mobile application 112 operating on a mobile device, a mobile backend 114, a wallet broker 124, a POS 126, and a wireless transmitter. The POS 126 emits a wireless signal, such as a Bluetooth low energy transmission, a beacon or the like, through the wireless transmitter 128 containing encoded/crypted information. The mobile device operating the mobile application 112 can be placed within proximity of the wireless transmitter 128 to detect and activate the appropriate functionality within the mobile application 112.

When the mobile application 112 receives the encoded/encrypted information, the mobile application 112 may perform one of two operations. In the first operation, the mobile application 112 may directly communicate with the wallet broker 124 to link to the wallet broker 124 with transaction allowing communication with the mobile backend 114 and the POS 126. The wallet broker 124 may then communicate with the mobile backend system 112 to gather additional/required information, such as, but not limited to a customer payment profile.

In the second operation, the mobile application 112 may directly communication with the mobile backend system 114. By communicating directly with the mobile backend system 114, the mobile application 112 may gather additional/required information, such as, but not limited to a customer payment profile and send the information to the wallet broker 124 as part of linking the wallet broker 124 to the transaction. Alternatively, the mobile application 116 may communicate with the mobile backend 118, which may gather information to send to the wallet broker 124, which will link the wallet broker 124 to the backend 118 and POS 126 for further information exchange, such as, but not limited to a customer payment profile.

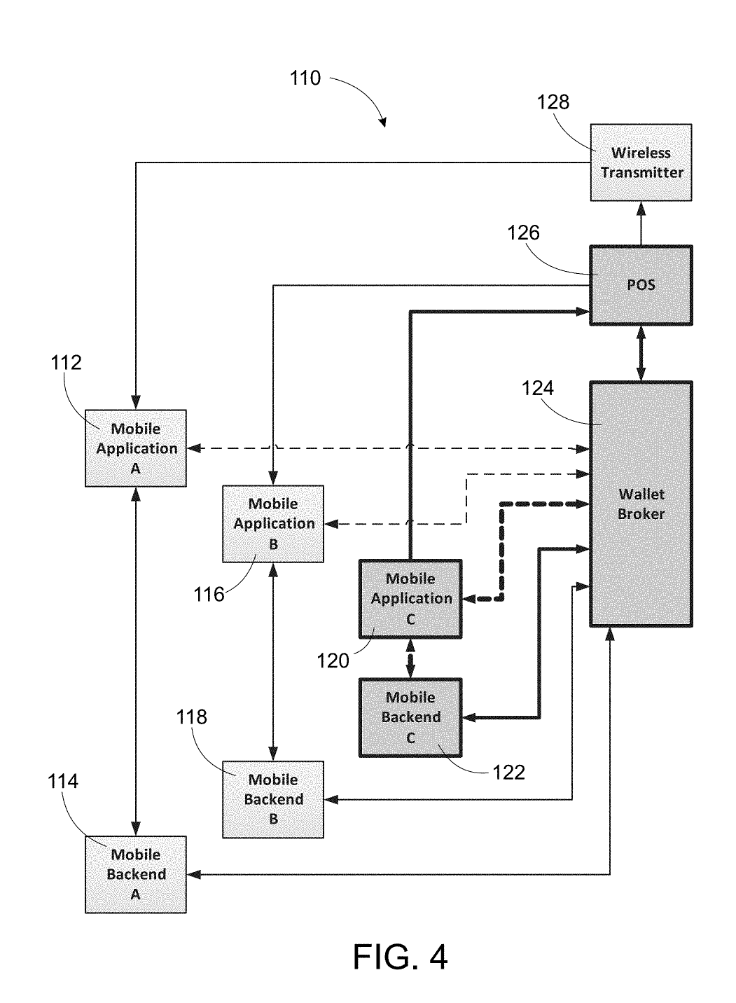

Referring to FIG. 4, the system 110 includes a third portion that comprises a mobile application 120 operating on a mobile device, a mobile backend 122, a wallet broker 124 and a POS 126. The mobile application 120 generates and displays a code, such as, but not limited to a QR code or one-dimensional barcode, that contains proprietary information. The POS 126 may scan and capture the proprietary information using a scanning device. The POS 126 may then communicated with the wallet broker 124 and transmit the proprietary information to the wallet broker 124.

The wallet broker 124 evaluates the content of the proprietary information and determines which mobile application 120 type was used. The wallet broker 124 may then communicate with the corresponding mobile backend system 122 to retrieve information, such as, but not limited to a customer payment profile.

With regard to FIGS. 1-4, the system 110 includes common operation for all portions of the system. Regardless of how a link to the transaction occurs, the wallet broker 124 will push or send data to the POS 126 in a standard format. Sufficient data will be return to allow the POS 126 to enforce tender-level rules. When the POS 126 is ready to tender and has enforced any rules, it will communicate with the wallet broker 124 requesting a payment authorization. The wallet broker may then create appropriate authorization message(s) and send one, or more, authorizations to either the appropriate authorizer 130, if payment credentials are available, or to the mobile application backend systems 114, 118, 122, which will augment the authorization request and send to the appropriate authorizer 130.

The POS 126 receives a standard message reporting the state of the authorization request(s). When the transaction is complete, the POS 126 alerts the wallet broker 124 so the link to the transaction can be closed and mobile backend systems 114, 118, 122 and/or mobile application 112, 116, 120 can be notified.

If supported by the mobile applications 112, 116, 120 and mobile backend systems 114, 118, 122, additional data can be sent to the POS 126 for processing, such as, but not limited to customer profile/preferences, discount cards, membership cards, basket information, electronic receipts and coupons/offers. Each of these different data may generally be included in the customer payment profile.

Some mobile applications 112, 116, 120 do not require additional communication to backend systems 114, 118, 122, that is the data captured in the code is sufficient to authorize payment because it is a payment credential. In these situations, the wallet broker 124 will simply skip the additional data gathering steps. Again, the POS 126 is not aware of the difference because it sees the same information. In some instances, it may be desired to send the payment credentials to the POS 126 to allow it to process the authorization through pre-existing payment integrations.

Some mobile payment solutions allow multiple tenders to be authorized out of the wallet. After the completion of the POS 126 receives a standard message reporting the state of the authorization request, the POS 126 can request additional tender information and communicate with the wallet broker 124.

The system 110 provides several improvements over the prior art. For example, it provides common user experience regardless of the mobile application; common cashier experience regardless of the mobile application; a single integration for the POS system and avoids having to change the POS to integrate a new mobile application; consistency of push notification simplifies mobile payment implementation since the POS may not be sure when a mobile application will sync or link to the transaction, or which application performed the sync; and improved security by minimizing payment credentials residing within the POS system.

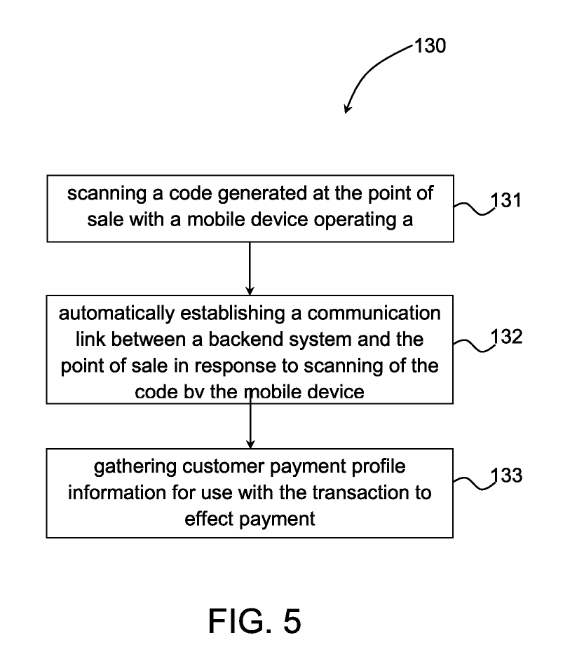

FIG. 5 depicts a method 130 of common user experience for executing mobile payment for a transaction at a point of sale in accordance with embodiments. The method may include scanning a code generated at the point of sale with a mobile device operating a mobile application, wherein the code includes encoded/encrypted information that is scannable by any participating mobile application (Step 131); automatically establishing a communication link between a backend system and the point of sale in response to scanning of the code by the mobile device, in order to link the backend system with the transaction (Step 132); and gathering customer payment profile information for use with the transaction to effect payment (Step 133).

Step 132 of establishing a communication link between the backend system and the point of sale further comprises sending encoded/encrypted information from the code to a wallet broker, wherein the wallet broker establishes a link to the point of sale and to the backend system.

Step 133 of gathering customer payment profile comprises accessing the backend system with the wallet broker in order to gather the customer payment profile. Step 133 of gathering customer payment profile information may also include gathering customer payment profile information from the backend system through the wallet broker.

The method 130 may further include sending customer payment profile information to a wallet broker.

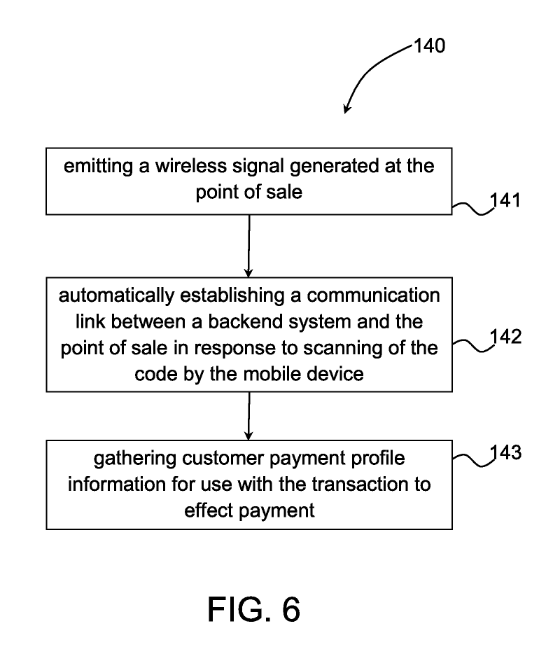

FIG. 6 depicts a method 140 of common user experience for executing mobile payment for a transaction at a point of sale in accordance with embodiments. The method 140 includes emitting a wireless signal generated at the point of sale, wherein the code includes encoded/encrypted information that is detectable by any participating mobile application operating on a mobile device (Step 141); automatically establishing a communication link between a backend system and the point of sale in response to scanning of the code by the mobile device, in order to link the backend system with the transaction (Step 142); and gathering customer payment profile information for use with the transaction to effect payment (Step 143).

Step 142 of establishing a communication link between the backend system and the point of sale further comprises sending encrypted information from the code to a wallet broker, wherein the wallet broker establishes a link to the point of sale and to the backend system.

Step 143 of gathering customer payment profile comprises accessing the backend system with the wallet broker in order to gather the customer payment profile. Step 143 of gathering customer payment profile information may also include gathering customer payment profile information from the backend system through a wallet broker.

The method 140 may further comprise sending customer payment profile information to a wallet broker.

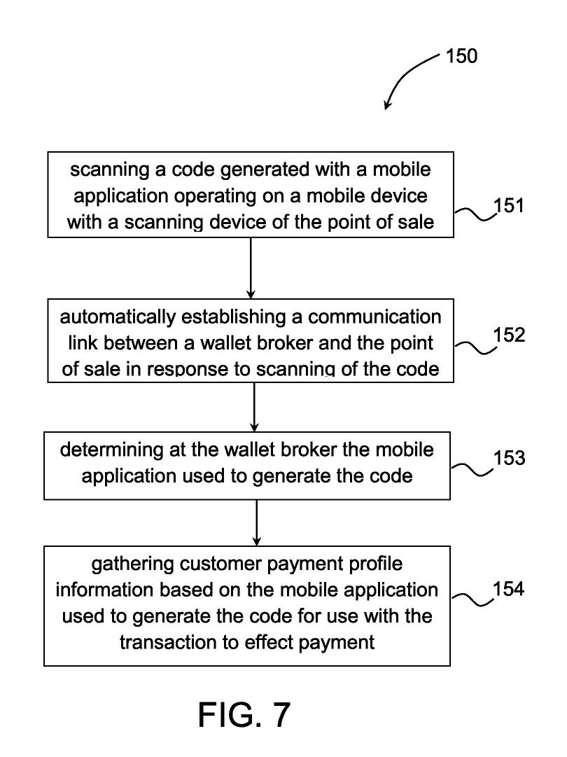

FIG. 7 depicts a method 150 of common user experience for executing mobile payment for a transaction at a point of sale according to embodiments. The method 150 may include scanning a code generated with a mobile application operating on a mobile device with a scanning device of the point of sale, wherein the code includes encoded/encrypted information (Step 151); automatically establishing a communication link between a wallet broker and the point of sale in response to scanning of the code, in order to link the wallet broker with the transaction (Step 152; determining at the wallet broker the mobile application used to generate the code (Step 153); and gathering customer payment profile information based on the mobile application used to generate the code for use with the transaction to effect payment (Step 154).

Step 152 of establishing a communication link between the wallet broker and the point of sale further comprises sending encoded/encrypted information from the code to the wallet broker. Step 154 of gathering customer payment profile comprises accessing the backend system with the wallet broker in order to gather the customer payment profile.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the invention has been shown and described with reference to specific preferred embodiments, it should be understood by those skilled in the art that various changes in form and detail may be made therein without departing from the spirit and scope of the invention as defined by the following claims.

What is claimed is:

1. A method of common user experience for executing mobile payment for a transaction
at a point of sale, the method comprising:
scanning a code generated at the point of sale with a mobile device operating a mobile application, wherein the code includes encoded/encrypted information that is scannable by any participating mobile application;
automatically establishing a communication link between a backend system and the point of sale in response to scanning of the code by the mobile device, in order to link the backend system with the transaction; and
gathering customer payment profile information for use with the transaction to effect payment.

2. The method of claim 1, wherein establishing a communication link between the backend system and the point of sale further comprises sending encoded/encrypted information from the code to a wallet broker from one of the mobile application or the mobile application through the backend system, wherein the wallet broker establishes a link to the point of sale and to the backend system.

3. The method of claim 2, wherein gathering customer payment profile comprises accessing the backend system with the wallet broker in order to gather the customer payment profile.

4. The method of claim 1, further comprising sending customer payment profile information to a wallet broker.

5. The method of claim 1, wherein gathering customer payment profile information includes gathering customer payment profile information from the backend system through the wallet broker.

6. A method of common user experience for executing mobile payment for a transaction
at a point of sale, the method comprising:
emitting a wireless signal generated at the point of sale, herein the code includes encoded/encrypted information that is detectable by any participating mobile application operating on a mobile device;
automatically establishing a communication link between a backend system and the point of sale in response to scanning of the code by the mobile device, in order to link the backend system with the transaction; and
gathering customer payment profile information for use with the transaction to effect payment.

7. The method of claim 6, wherein establishing a communication link between the backend system and the point of sale further comprises sending encoded/encrypted information from the code to a wallet broker, wherein the wallet broker establishes a link to the point of sale and to the backend system.

8. The method of claim 7, wherein gathering customer payment profile comprises accessing the backend system with the wallet broker in order to gather the customer payment profile.

9. The method of claim 6, further comprising sending customer payment profile information to a wallet broker.

10. The method of claim 6, wherein gathering customer payment profile information includes gathering customer payment profile information from the backend system through a wallet broker.

11. A method of common user experience for executing mobile payment for a transaction
at a point of sale, the method comprising:
scanning a code generated with a mobile application operating on a mobile device with a scanning device of the point of sale, wherein the code includes encoded/encrypted information;
automatically establishing a communication link between a wallet broker and the point of sale in response to scanning of the code, in order to link the wallet broker with the transaction;
determining at the wallet broker the mobile application used to generate the code; and
gathering customer payment profile information based on the mobile application used to generate the code for use with the transaction to effect payment.

12. The method of claim 11, wherein establishing a communication link between the wallet broker and the point of sale further comprises sending encoded/encrypted information from the code to the wallet broker.

13. The method of claim 12, wherein gathering customer payment profile comprises accessing the backend system with the wallet broker in order to gather the customer payment profile.

14. A system for providing a common experience using a mobile wallet, the system comprising:
a mobile device operating a mobile application;
a mobile backend system corresponding to the mobile application;
a point of sale; and
a wallet broker, wherein:
the wallet broker links to a transaction performed at the point of sale to place the wallet broker in communication with the mobile application, mobile backend system and the point of sale;
the wallet broker communicates the mobile backend system to obtain a customer payment profile;
the wallet broker sends an authorization message to the corresponding backend system for authorization in response to receiving a request for payment authorization from the point of sale; and
the wallet broker sends a standard message to the point of sale reporting the state of the authorization request.

15. The system of claim 14, wherein the wallet broker is linked to the transaction in response to the mobile device operating the mobile application scanning a code generated by the point of sale, wherein the code includes the encoded/encrypted information.

16. The system of claim 14, wherein the wallet broker is linked to the transaction in response to the point of sale scanning a code generated by the mobile application operating on the mobile device, wherein the code includes the encoded/encrypted information.

17. The system of claim 14, wherein the wallet broker is linked to the transaction in response to the point of sale emitting a wireless signal containing the encoded/encrypted information through a wireless transmitter, wherein wireless signal is detectable by the mobile application operating on the mobile device.

18. The system of claim 14, wherein the point of sale communicates with the wallet broker to notify the wallet broker that the sale is complete, wherein the link of the wallet broker to the transaction is closed.

19. The system of claim 18, wherein the mobile application or mobile backend is notified of a completed transaction from the wallet broker in response to the wallet broker receiving a notification that the sale is complete.

20. The system of claim 14, wherein the customer payment profile includes one or more of customer profile/preferences, discount cards, membership cards, basket information, electronic receipts, and coupons/offers.

21. The system of claim 14, wherein the wallet broker pushes data to the point of sale in a standard format.

22. The system of claim 21, wherein sufficient data is pushed to the point of sale to allow the point of sale to enforce tender-level rules.

23. The system of claim 22, wherein the point of sale communicates with the wallet broker requesting a payment authorization after the point of sale has enforced tender-level rules.

24. The system of claim 23, wherein the wallet broker creates appropriate authorization message(s) and send one or more authorizations to either the appropriate authorizer, if payment credentials are available, or to the mobile application backend system, which will augment the authorization request and send to the appropriate authorizer.
